(19) United States
(12) Patent Application Publication
(10) Pub. No.: US 2014/0299643 A1
(43) Pub. Date: Oct. 9, 2014

(54) Trunk Storage Device

(71) Applicant: Paul Forgione, Wakefield, MA (US)

(72) Inventor: Paul Forgione, Wakefield, MA (US)

(21) Appl. No.: 14/311,398

(22) Filed: Jun. 23, 2014

Related U.S. Application Data
(63) Continuation-in-part of application No. 13/482,479, filed on May 29, 2012, now Pat. No. 8,794,494.

(51) Int. Cl. B60R 7/00

(52) U.S. Cl. CPC B60R 7/00
USPC 224/539

(57) ABSTRACT

A trunk storage device is provided. The trunk storage device may have a base constructed to be substantially planar, a storage unit attached to an edge of the base, and a connection portion connecting the storage unit to the base. The connection portion may provide a spacing between the base and the storage unit to allow passage of a mat positioned at a bottom of a vehicle trunk.

### PRIORITY CLAIM

This application is a continuation-in-part utility patent application which claims the benefit to and priority from non-provisional utility patent application Ser. No. 13/482,479 filed on May 29, 2012.

### BACKGROUND OF THE INVENTION

1. Field of the Invention

The present invention relates generally to storage devices for a trunk of a vehicle. More particularly, the present invention relates to a trunk storage device that is secured under a mat in a vehicle trunk.

2. Description of Related Art

A vehicle trunk provides a cavity in which to store a number of items of varying size. However, in some cases, the trunk is substantially larger than the contents stored therein. As such, during acceleration, cornering, and braking, small objects, particularly round objects may roll and tumble about within the trunk. This rolling and tumbling may cause irritating and upsetting noises, and further may cause damage to the objects as well as the vehicle.

Unfortunately, there has been no effective trunk storage device available to the automobile owner. Instead, such items as oil and windshield washer fluid are often simply placed loosely in the trunk where they can roll about making considerable noise and can even spill causing undesirable staining of trunk carpeting and/or other items carried in the trunk. Of course, the same holds true for transmission fluid, brake fluid and coolant.

Therefore, what is needed is a device that may conveniently and effectively provide a storage area for items within the trunk, to retain and organize these items.

### SUMMARY OF THE INVENTION

The subject matter of this application may involve, in some cases, interrelated products, alternative solutions to a particular problem, and/or a plurality of different uses of a single system or article.

In one aspect, a storage device is provided. The storage device may comprise a substantially planar base and a storage unit attached to the base. The storage unit may be attached to the base by a connection portion of the base, the base being sized and configured to provide support for the storage unit. Further, the connection portion may form a spacing between the storage unit and the base when connected. This spacing may be sized to allow passage of a mat of a vehicle trunk, such that the storage device is secured by the mat.

In another aspect, an automotive vehicle having a trunk storage device is provided. The vehicle may comprise a trunk, and a trunk storage device secured within the trunk. The trunk storage device being constructed and arranged to secure an item substantially smaller than the trunk itself. The trunk storage device may comprise a base, the base being positioned under a mat of the vehicle trunk. The trunk storage device may further comprise a storage unit, the storage unit attached to the base by a connection portion, and positioned above the mat of the trunk. The connection portion may separate the base and the storage unit, creating a spacing between the two. The trunk mat is positioned in this spacing between the base and the storage unit.

In yet another aspect, a method of installing a storage device into a trunk of a vehicle is provided. The method comprises the steps of: lifting a part of a mat from a bottom of the vehicle trunk, and sliding a planar base of the storage device between the mat and the bottom of the trunk. Further, the method comprises the steps of positioning a storage unit of the storage device over the mat, the storage unit connected to the base by a connection portion. Finally the method comprises placing the part of the mat into a spacing formed by the connection portion between the base and the storage unit.

### BRIEF DESCRIPTION OF THE DRAWINGS

FIG. 1 provides a perspective view of the storage device.

FIG. 2 provides a perspective view of another embodiment of the storage device.

FIG. 3 provides a side view of an embodiment of the storage device.

FIG. 4 provides a side view of another embodiment of the storage device.

FIG. 5 provides an elevation view of the storage device mounted in a vehicle trunk.

FIG. 6 provides a perspective view of an embodiment of the storage device.

FIG. 7 provides a perspective view of another embodiment of the storage device.

FIG. 8 provides a side view of another embodiment of the storage device.

### DETAILED DESCRIPTION

The detailed description set forth below in connection with the appended drawings is intended as a description of presently preferred embodiments of the invention and does not represent the only forms in which the present invention may be constructed and/or utilized. The description sets forth the functions and the sequence of steps for constructing and operating the invention in connection with the illustrated embodiments.

Generally, the present invention concerns a trunk storage device. The trunk storage device may have a base constructed to be substantially planar, a storage unit attached to an edge of the base, and a connection portion connecting the storage unit to the base. The connection portion may provide a spacing between the base and the storage unit to allow passage of a mat of a vehicle trunk. In operation, the base may be positioned below the mat, while the storage unit may be positioned above the mat, allowing access to the storage unit from the trunk interior.

Typically, a trunk of a vehicle is provided with a mat at its bottom to separate the sheet metal of the vehicle at a bottom of the trunk from an interior of the trunk. This both protects the metal of the vehicle, as well as the items stored within the trunk. The mat of the trunk generally is shaped to cover the entirety of the base of the trunk, fitting snugly within the trunk. This mat may be lifted up partially, allowing the base of the storage device to be placed under the mat.

In one embodiment, the base may be formed as a substantially planar sheet. The base may have any shape that allows it to support the storage unit and remain substantially stationary when secured under the mat of the trunk.

In another embodiment, the base may be formed as a substantially planar wire or tubular shaped material, configured to form a perimeter of the base. The wire may have any shape and form any perimeter that allows it to support the storage unit and remain substantially stationary when secured under the mat of the trunk.

The base may be constructed of any material substantially rigid enough to support a storage unit against forces experienced during driving. Such forces may include acceleration, cornering, braking and/or crashing. Examples of materials of which the base may be made include plastics, metals, composite materials, wood, particle board, or ceramics, among others.

The base may be formed in any shape and size having a width and length capable of providing support to the storage unit. Shapes of the base may include, but are not limited to, a square, rectangle, triangle, pentagon, circle or oval. In a further embodiment, the base may have a shape substantially corresponding to a contour of a trunk wall. In another embodiment, the base may be custom shaped depending on a particular vehicle model's trunk shape.

A storage unit may be attached to the base. In one embodiment, the storage unit may be permanently attached to the base. In another embodiment, the storage unit may be removably attached from the base. In still another embodiment, the storage unit may be integrally formed with the base, and connected by a connection portion extending from the base to the storage unit. In yet another embodiment, the base may form a protrusion receivable by a detent of the storage unit. The storage unit may be removably attached to the base by placement of the protrusion of the base in the detent of the storage unit.

In embodiments wherein the storage unit is removably attached from the base, the storage unit may be attached to the base in any removable manner. For example, attachment structures connecting the storage unit to the base may include a snap fit, threaded attachment, a pressure fit, and a male-female prong configuration allowing the storage unit to remain in place, among others.

The storage unit may be of any shape and size that may provide convenient storage and/or organization of small items stored within a vehicle trunk. Generally, the storage unit may comprise a bounding sidewall or sidewalls that create a storage area. The sidewall may form a continuous surface, or may be non-continuous. Optionally, the storage unit may comprise a bottom surface, and a cover.

In one embodiment, the storage unit may be formed by a sidewall or sidewalls forming a substantially cylindrical storage unit. In a further embodiment, a cylindrical storage unit may be sized to form a storage area to receive a standard sized 1 gallon windshield washer fluid container. In this embodiment, the washer fluid container may be secured within the storage area. The round shape of the washer fluid container, along with its weight and spillable contents, makes it prone to rolling, crashing, and potentially spilling in a trunk during driving conditions. As such, washer fluid containers are a prime candidate for storage within the storage unit.

In another embodiment, the storage unit may be formed by a sidewall or sidewalls forming a substantially box shaped storage unit. In this embodiment, various items may be stored within the rectangular storage area. For example, the storage unit may be sized to receive gas tanks with a rectangular cross section that may fit snugly within the storage unit. Further, in another embodiment, a plurality of small tools and other items may be stored within the storage area.

In still another embodiment, one or a plurality of dividers may be positioned within the storage unit. The dividers may serve to break the internal storage area into a plurality of smaller storage areas, to aid in organization of placement and storage of small items.

The storage unit may be constructed of any material rigid and durable enough to hold varying items against the forces experienced during the driving of a motor vehicle. Examples of materials of which the storage unit may be made include plastics, metals, composite materials, wood, particle board, or ceramics, among others.

In another embodiment, the base may have a plurality of connection portions, allowing for attachment of a plurality of storage units to the base. In this embodiment, multiple storage units may be utilized to store different items, and may be attached to a single base. In a further embodiment, a plurality of storage units may be removably mountable to the base, and may be interchanged depending on what the user desires to store in the storage device. For example, if a gas tank and windshield washer fluid container are to be stored, storage units designed for such storage may be attached to the base, and the tank and container may be stored in their appropriate storage units.

In still a further embodiment, a plurality of trunk storage devices may be mounted within a single trunk, the base of each storage device positioned under the trunk mat, and the storage unit of each storage device positioned over the mat.

It is important to note that the connection portion of the base forms a spacing between the base and the storage unit when attached. This spacing is sized to allow passage of at least a mat of the trunk. This configuration allows the base to be positioned under the mat, securing the storage device, while the storage unit is positioned over the mat.

In one embodiment of use, the storage device may be installed by a user lifting up a mat of a vehicle's trunk, and sliding the base of the storage device under the mat. The mat may then be returned to its original, resting position by being slid between a spacing between the base and storage unit. Once the mat is returned to its original position, the storage device will be in a secured operating position, and various items may be placed securely within the storage unit.

The storage device may be manufactured in any manner to allow efficient construction of the device. In one embodiment, the storage unit may be formed from a single sheet of plastic material. In this embodiment, a flat rectangular sheet of plastic may be cut in two places on opposite sides of the sheet, the cuts being approximately ⅕-⅓ of the width of the sheet. Next, the cut sides may be folded inwardly to either connect, or nearly connect, thereby forming the storage area. The uncut region of the plastic sheet may then be folded upward such that its sides are approximately perpendicular to the remainder of the sheet. In this embodiment, the cuts may be of a moderate width, such that the uncut region forms a spacing when folded upward. Once this folding is completed, the plastic sheet may be processed to retain its shape.

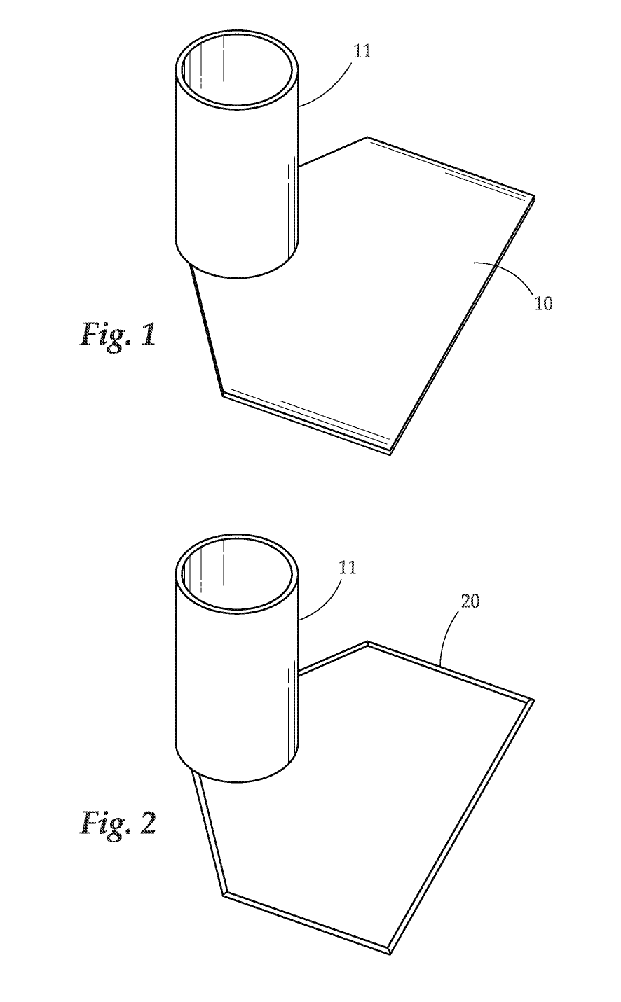

Turning now to FIG. 1 a perspective view of the storage device is shown. This figure shows an embodiment where the storage unit 11 is in a cylindrical shape with a substantially circular cross section. The storage unit 11 is attached to an edge of the base 10. The base 10 is formed as a continuous sheet, and is sized to slide under a mat of a vehicle trunk.

FIG. 2 shows a perspective view of another embodiment of the storage device. In this embodiment, the base 20 is formed as a wire frame. The storage unit 11 is shown here as having a cylindrical shape with a substantially circular cross section. The storage unit 11 is attached to an edge of the base 20 via a connection portion (not shown).

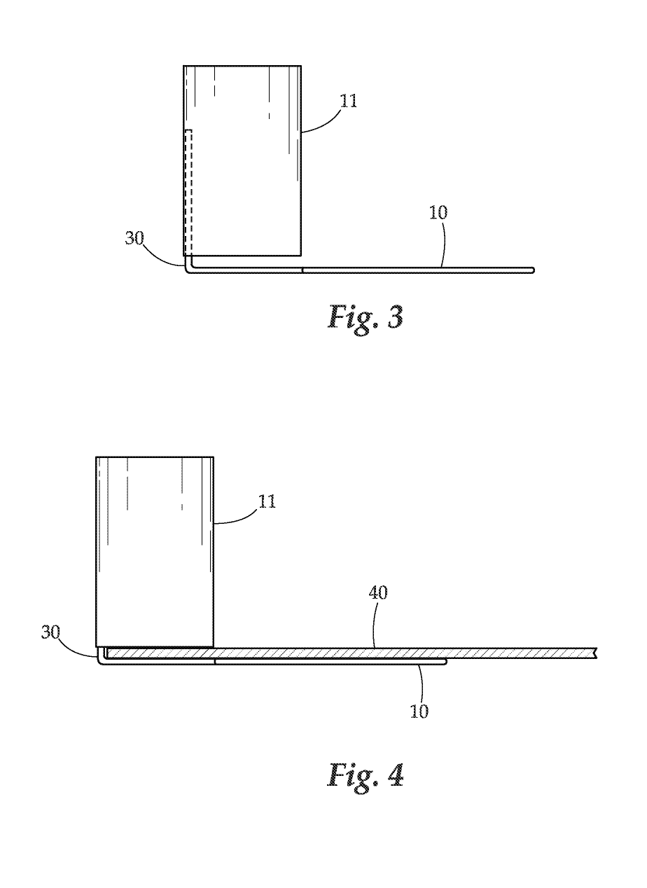

FIG. 3 provides a side view of an embodiment of the storage device. The base 10 is substantially flat and fairly narrow. A connection portion 30 of the base extends upwards and connects to the storage unit 11. The connection portion 30 provides a spacing between the storage unit 11 and the base 10 through which a mat of a vehicle may pass.

FIG. 4 provides a side view of another embodiment of the storage device. The base 10 is substantially flat and fairly narrow. A connection portion 30 of the base extends upwards and connects to the storage unit 11. The connection portion 30 provides a spacing between the storage unit 11 and the base 10 through which a mat 40 of a vehicle may pass. The base 10 can be seen positioned below the mat 40 and secured thereby. The storage unit 11 is positioned above the mat 40, providing access from the trunk interior.

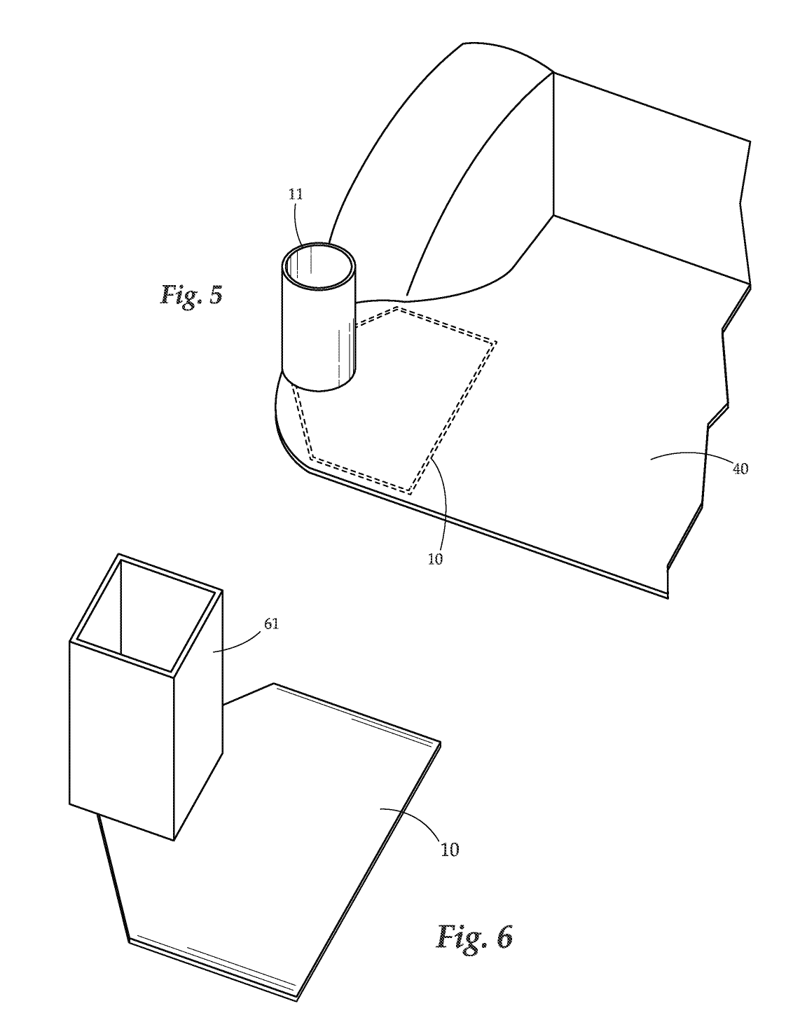

FIG. 5 provides an elevation view of an embodiment of the storage device mounted within a vehicle trunk. The base 10 is positioned under the trunk mat 40, and secured by the mat 40. A storage unit 11 is connected to the base by a connection portion (not shown) and is positioned over the mat 40 allowing storage of components therein.

FIG. 6 provides an embodiment of a perspective view of the storage device. This figure shows an embodiment where the storage unit 61 is in a box shape with a substantially rectangular cross section. It should be understood, however, that the storage unit 61 may be of any shape and size, and may include compartments for various articles of different sizes and shapes. The storage unit 61 is attached to an edge of the base 10 by a connection portion (not shown). The base 10 is formed as a continuous sheet, and is sized to slide under a mat of a vehicle trunk.

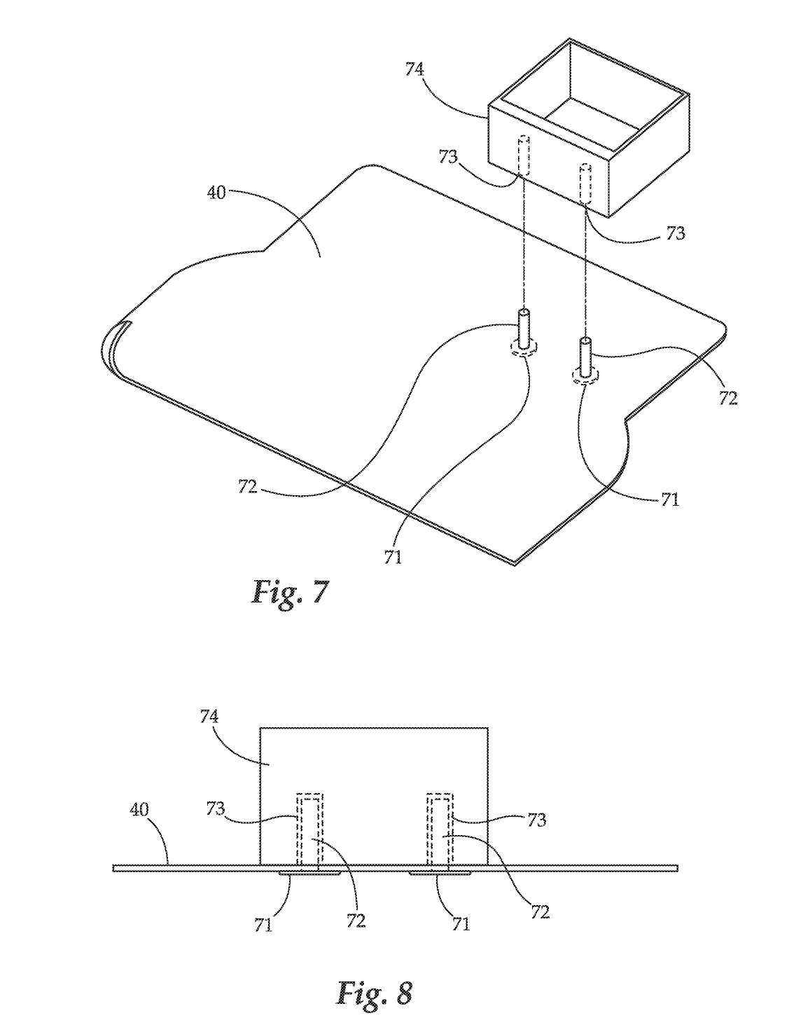

FIGS. 7 and 8 provide a perspective and side view of another embodiment of the present invention. In this invention, storage unit 74 is shown as a rectangular storage unit. However, it should be understood that the storage unit may be of any shape, such as circular, rounded, oval, triangular, and the like. In particular embodiments, the storage unit 74 may be specifically sized to receive a standard sized gas can (such as a two or five gallon can), or may be sized to receive a standard sized windshield washer fluid container. Storage unit 74 contains two cutout areas 73 which are sized to slideably receive posts 72. As such, an inner diameter (or dimensions depending on shape) of the cutout 73 may be just slightly larger than the outer diameter or dimensions depending on shape) of post 72. Upon being placed on the posts 72, the storage unit 74 is held in position, until lifted up and away from the posts. Each post 72 is anchored under trunk mat 40 by flanged head 71. The size of the flanged head 71 may vary to be any size. Size of the flanged head 71 may be selected depending on embodiment and size of the storage unit 74. In one embodiment, the flanged head 71 may have a radius equal to a height of the post 72.

While several variations of the present invention have been illustrated by way of example in preferred or particular embodiments, it is apparent that further embodiments could be developed within the spirit and scope of the present invention, or the inventive concept thereof. However, it is to be expressly understood that such modifications and adaptations are within the spirit and scope of the present invention, and are inclusive, but not limited to the following appended claims as set forth.

1-20. (canceled)

21. A storage device comprising:
a storage unit comprising a storage area and a cutout region in a wall;
a post positioned at least partially within the cutout region, the post comprising a flanged head at a distal end not positioned within the cutout region; and
a vehicle trunk mat having the post protruding through an aperture defined by the mat, the mat being positioned between the flanged head and the storage unit.

22. The storage device of claim 21 wherein the storage unit is removably attached to the post.

23. The storage device of claim 21 further comprising a second cutout of the wall, and a second post positioned partially within the second cutout, the second post further extending through the mat and comprising a flanged head at a distal end and on an opposite side of the mat from the storage unit.

24. The storage device of claim 21 wherein the storage unit is formed as a rectangular box.

25. The storage device of claim 24 wherein the rectangular box has a gas tank containing gasoline securely positioned therein.

26. The storage device of claim 21 wherein the storage unit is formed as a cylinder.

27. The storage device of claim 21 wherein the cylinder has a windshield washer container containing windshield washer fluid securely positioned therein.

28. The storage device of claim 21 wherein the post has an outer diameter slightly smaller than an inner diameter of the cutout.

29. The storage device of claim 21 wherein the storage unit is slideably removable and attachable to the post.

30. An automotive vehicle comprising:
a passenger section and a trunk, the trunk being separate and isolated from the passenger section, a bottom of the trunk having a mat placed thereon;
a trunk storage device secured within the trunk, the trunk storage device comprising:
a storage unit comprising a storage area and a cutout region in a wall;
a post positioned at least partially within the cutout region, the post comprising a flanged head at a distal end not positioned within the cutout region; and
a vehicle trunk mat on the trunk floor having the post protruding through an aperture defined by the mat, the mat being positioned between the flanged head and the storage unit.

31. The automotive vehicle of claim 30 wherein the flanged head has a radius that is greater than a height of the post.

32. The automotive vehicle of claim 30 further comprising a gas can containing gasoline secured within the storage unit, the storage unit being sized to receive the gas can.

33. The automotive vehicle of claim 30 further comprising a windshield washer fluid container containing windshield washer fluid, the storage unit being sized to receive the windshield washer fluid container.

34. The automotive vehicle of claim 30 wherein the storage unit is removably attached to the post.

35. The automotive vehicle of claim 30 further comprising a second cutout of the wall, and a second post positioned partially within the second cutout, the second post further extending through the mat and comprising a flanged head at a distal end and on an opposite side of the mat from the storage unit.

36. The automotive vehicle of claim 30 wherein the post has an outer diameter slightly smaller than an inner diameter of the cutout.
